(19) United States
(12) Patent Application Publication
(10) Pub. No.: US 2025/0354427 A1
(43) Pub. Date: Nov. 20, 2025

(54) METHOD FOR DETECTING A MOVEMENT OF A FLAP OF A MOTOR VEHICLE

(71) Applicant: MAGNA Auteca GmbH, Weiz (AT)

(72) Inventor: Bernhard LAMPRECHT, Magdalensberg (AT)

(21) Appl. No.: 19/281,683

(22) Filed: Jul. 27, 2025

(30) Foreign Application Priority Data
Sep. 24, 2023 (EP) 24202110.3

(51) Int. Cl. E05F 15/611; H02P 6/18; H02P 6/185

(52) U.S. Cl. CPC E05F 15/611; H02P 6/185; H02P 6/186; E05Y 2400/36

(57) ABSTRACT

A method for detecting movement of a vehicle body component moveable by an electric motor having a rotor and a three-phase stator, and a motor vehicle. The method includes: loading two stator phases with a pulse-width-modulated voltage and maintaining a third stator phase at a free-floating state; monitoring the third stator phase as a measuring point for an inductive voltage divider formed using the two stator phases; and detecting movement of the vehicle body component when an electric signal at a measuring point or a variable derived from the electric signal exceeds a specified threshold value. The motor vehicle includes a control device that is operable to perform the method.

### CROSS-REFERENCE TO RELATED APPLICATIONS

The present application claims priority under 35 U.S.C. § 119 to European Patent Publication No. EP 24202110.3 (filed on Sep. 24, 2024), which is hereby incorporated by reference in its complete entirety.

### TECHNICAL FIELD

The present disclosure relates to a method for detecting a movement of a pivotable vehicle body component, particularly, a flap of a motor vehicle, and a motor vehicle. A control device of the motor vehicle is configured to carrying out such a method in order to detect movement of a pivotable vehicle body component of the motor vehicle.

### BACKGROUND

It is known that motor vehicles comprise pivotable vehicle body components, such as doors, tailgates, fuel doors, etc. Today, such flaps can sometimes be closed and/or opened electrically via application of a drive force of an electric motor.

In order to detect the user desire to open or close an electrically actuated flap, sensors or switches are frequently used, which start the electrical opening or closing process following actuation. Often however, opening or closing is desired following a short manual movement (so-called “tip to run”): the user starts the opening or closing process by hand and the electric mechanism (electric motor, gear unit) is subsequently activated and completes the opening or closing process. Such a method is known from CD drives, for example from U.S. Pat. No. 8,799,934B2. European Patent Publication No. EP3554875B1, for example, discloses that a back-induced voltage can be measured to initiate a closing process.

The use of external sensors or switches increases the number of components in the system and therefore the costs of the motor vehicle. The measurement of the back-induced voltage is speed-dependent. Depending on the gear ratio between the component to be moved and the electric motor, very slow movements generate a back-induced voltage that is too low and the manual actuation is not detected.

### SUMMARY

It is an object of the present disclosure to specify a method for detecting a movement of a pivotable vehicle body component, which can reliably detect an opening and/or closing process and can be implemented inexpensively, and to specify a motor vehicle which can carry out such a reliable and inexpensive method for detecting an opening and/or closing movement.

The object is achieved by a method for detecting a movement of a pivotable vehicle body component, particularly a flap of a motor vehicle, in which the motor vehicle comprises an electric motor having a stator and a rotor, the electric motor being configured to open and/or to close the pivotable vehicle body component electrically. The electric motor comprises a brushless DC (BLDC) motor having a three-phase stator, having two phases thereof that are loaded with a pulse-width-modulated voltage and a third phase that is kept free-floating. The third phase is monitored as a measuring point for an inductive voltage divider which is formed using the two other phases. When the electric signal at the measuring point or a variable derived from the signal exceeds a specified threshold value, a movement, particularly, an opening or closing movement, of the pivotable vehicle body component is detected.

In accordance with the present disclosure, a BLDC motor with a three-phase stator is used to monitor an opening and/or closing process of a flap which is usually connected via a gear unit to the rotor of the BLDC motor. By using a three-phase BLDC motor and a suitable coil energization, it is possible to reliably determine changes of the rotor position. These changes in the rotor position can be quantified, compared with a threshold value and interpreted as a desire to open or to close the flap, the handle, the door, etc.

The detection of a manual component movement takes place in this case via a movement of the rotor and the start of an electrical movement of the pivotable vehicle body component is possible after that. By using components which are already necessary for the electrical actuation of the flap, it is possible to save additional components and thus costs. The detection of the manual movement is speed-independent in this case, above all and also in contrast to the measurement of a back-induced voltage.

An external manual movement at a flap, for example a door, effects an angular change of the rotor inside the drive via a non-self-locking gear unit. The stator of the motor is realized with three phases, with the individual phases being star-connected. When the motor is at a standstill, two phases are loaded with a pulse-width-modulated voltage having a different pulse width in each case, and the third phase is kept free floating in terms of potential (so-called “tri-state”). The third phase then forms a measuring point for an inductive voltage divider which is formed using the two other phases. Should the location of the magnetic poles of the rotor changes in relation to the poles of the stator, the inductances of the voltage divider change and this change can be measured at the free-floating phase. It is therefore possible to determine a rotation of the rotor and, by counting the periodic fluctuations, also the angle of the rotation. Using a corresponding logic, the result that is obtained can then be interpreted as a desire of the user to open or to close the flap, the door, etc. After that, the drive can start an electrical adjustment of the pivotable component.

Preferably, the signal that is measured at the measuring point, preferably the star point voltage, is monitored continuously. In this case, periodic fluctuations of the signal are preferably counted at the measuring point, in order to determine an angle of the rotation of the rotor.

Preferably, the signal that is measured at the measuring point is monitored continuously. The direction of rotation of the rotor is determined depending on a type of fluctuation of the signal at the measuring point. In particular, the direction of rotation of the rotor can be determined depending on the direction in which the star point voltage fluctuates in the time course relative to the star point voltage at the central position of the rotor at the start and at the end of the adjustment movement.

A motor vehicle in accordance with the present disclosure comprises a pivotable vehicle body component (e.g., a flap); an electric motor, having a stator and a rotor, configured to move the pivotable vehicle body component electrically; and a control device configured to carry out a method as described herein, in order to detect a manual external movement of the pivotable vehicle body component by a user of the motor vehicle. The electric motor comprises a BLDC motor having a three-phase stator. Preferably, the control device is configured, after detecting manual movement of the pivotable vehicle body component, to initiate an electrical opening and/or closing of the pivotable vehicle body component.

Developments of the present disclosure are specified in the dependent claims, the description and the accompanying drawings.

### DRAWINGS

The present disclosure is described by way of example in the following, with reference to the drawings.

FIG. 1 is a schematic illustration, particularly an equivalent circuit diagram, of a stator of a motor vehicle in accordance with the present disclosure.

FIG. 2 schematically shows an example measurement using an oscilloscope at a stator of the motor vehicle in accordance with the present disclosure in accordance with FIG. 1. The top graph represents PWM pulses at phases A and B, the middle graph represents star point voltage at phase C, and the bottom graph represents current through L1 and L2.

FIG. 3 schematically shows the change of the star point voltage at phase C when the rotor is moved out of its central position via the external action of force in one direction.

FIG. 4 schematically shows the change of the star point voltage at phase C when the rotor is moved out of its central position via the external action of force in the opposite direction to the direction in accordance with FIG. 3.

### DESCRIPTION

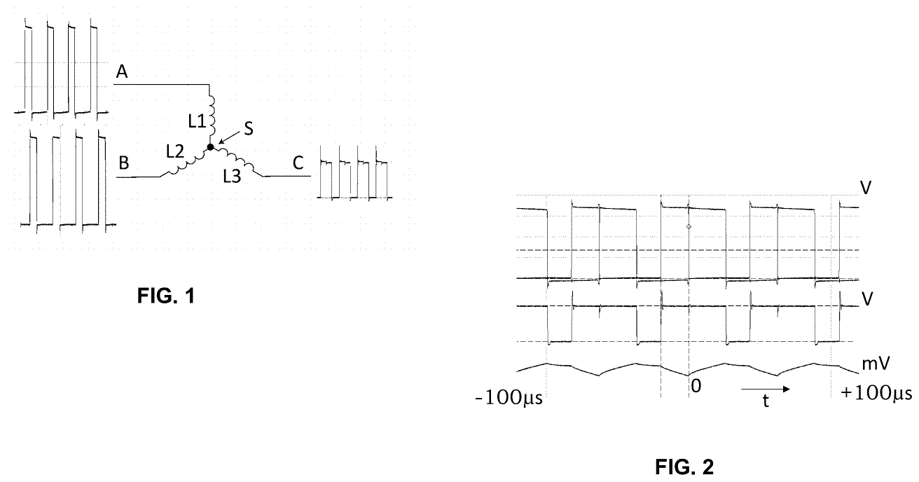

FIG. 1 schematically illustrates a stator of a motor vehicle in accordance with the present disclosure and the three-phase stator in a method in accordance with the present disclosure.

PWM pulses with the same pulse height are applied at two phases (A, B) of a three-phase BLDC motor (equivalent circuit diagram stator in FIG. 1). The PWM pulses at A and B have a time offset and are never active at the same time. By means of the pulse width (difference in the pulse width between A and B), a defined current is set by the coils L1 and L2 so that the rotor is held in position. If the pulse width of A is wider than that of B, then on average a current flows from A to B. The coil L3 carries no current. At phase C, it is possible to measure the voltage of the star point S. The level of the measured star point voltage at C without a rotor inserted is half the pulse height at A and B-principle of a voltage divider. The inductance and the ohmic resistance of L1, L2 and L3 are identical. The measurement principle is also suitable however if L1 is unequal to L2 and/or L2 is unequal to L3.

Should the rotor be inserted into the stator, then the inductance of L1 and L2 also changes (likewise L3, but this is not essential for the effect of the present disclosure however). The rotor can then be positioned such that half the pulse height of A or B is still measured at the star point S. The rotor automatically assumes this position if no load is acting on the rotor and it can move freely. The rotor is moved into this position by the current through L1 and L2 and the magnetic force that results from that. FIG. 2 shows an example measurement for that using an oscilloscope. Here, the course of two curves, which is illustrated at the top, shows the applied PWM pulses at phases A and B over time. The illustration in the middle of FIG. 2 shows the star point voltage at phase C, which is measured at the measuring point, over the same time course. The curve at the bottom in FIG. 2 shows the current through the coils or inductors L1 and L2.

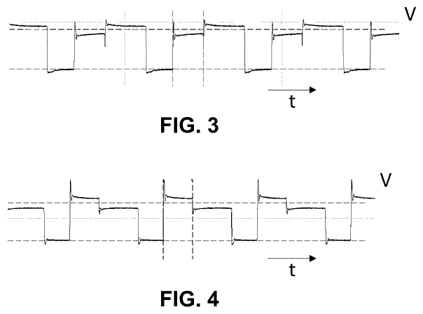

Should the rotor be moved out of its central position via the external action of force in one direction, then the star point voltage changes as illustrated in FIG. 3.

Should, by contrast, the rotor be moved out of its central position via the external action of force in the other, opposite direction, then the star point voltage changes as illustrated in FIG. 4.

By continuously monitoring and evaluating the star point voltage, particularly at the start and at the end of the external adjustment movement, it is therefore possible to detect the direction in which a force is acting on the rotor.

Should the external force be increased further, so that the rotor performs an electrical rotation (“jump by one pole pair”), then the star point voltage changes abruptly, either from a course as illustrated in FIG. 3 to a course as in FIG. 4 or from a course as illustrated in FIG. 4 to a course as illustrated in FIG. 3. This depends on the direction of rotation of the rotor. By continuously measuring and evaluating these changes, it is therefore possible to count the extent of the external adjustment with “pole-pair accuracy.” Furthermore, the direction of rotation of the external adjustment can also be detected using this.

Upon the detection of a rotor movement and thus a manual movement of the pivotable vehicle body component, this vehicle body component can be opened or closed further electrically or in an electrically assisted manner (tip to run).

### LIST OF REFERENCE SYMBOLS

A Stator, phase A
B Stator, phase B
C Stator, phase C
L1 Inductor 1
L2 Inductor 2
L3 Inductor 3
S Star point

What is claimed is:

1. A method for detecting movement of a vehicle body component moveable by an electric motor having a rotor and a three-phase stator, the method comprising:
loading two stator phases with a pulse-width-modulated voltage and maintaining a third stator phase at a free-floating state;
monitoring the third stator phase as a measuring point for an inductive voltage divider formed using the two stator phases; and
detecting movement of the vehicle body component when an electric signal at a measuring point or a variable derived from the electric signal exceeds a specified threshold value.

2. The method of claim 1, wherein the two stator phases are loaded with the pulse-width-modulated voltage in a time-offset manner to prevent activation of the two stator phases at the same time.

3. The method of claim 1, wherein the two stator phases are loaded with a same amplitude of the pulse-width-modulated voltage.

4. The method of claim 1, further comprising continuously monitoring the electric signal.

5. The method of claim 4, further comprising determining an angle of rotation of the rotor by counting periodic fluctuations of the electric signal.

6. The method of claim 4, further comprising determining a direction of rotation of the rotor depending on a type of fluctuation of the electric signal.

7. The method of claim 1, wherein the electric motor comprises a brushless DC (BLDC) motor.

8. The method of claim 1, wherein the vehicle body component comprises a pivotably moveable flap.

9. A method for operating a motor vehicle having a vehicle body component moveable by an electric motor having a rotor and a three-phase stator, the method comprising:
loading two stator phases with a pulse-width-modulated voltage and maintaining a third stator phase at a free-floating state;
monitoring the third stator phase as a measuring point for an inductive voltage divider formed using the two stator phases; and
detecting movement of the vehicle body component when an electric signal at a measuring point or a variable derived from the electric signal exceeds a specified threshold value.

10. The method of claim 9, wherein the two stator phases are loaded with the pulse-width-modulated voltage in a time-offset manner to prevent activation of the two stator phases at the same time.

11. The method of claim 9, wherein the two stator phases are loaded with a same amplitude of the pulse-width-modulated voltage.

12. The method of claim 9, further comprising continuously monitoring the electric signal.

13. The method of claim 12, further comprising determining an angle of rotation of the rotor by counting periodic fluctuations of the electric signal.

14. The method of claim 12, further comprising determining a direction of rotation of the rotor depending on a type of fluctuation of the electric signal.

15. The method of claim 9, wherein the electric motor comprises a brushless DC (BLDC) motor.

16. The method of claim 9, wherein the vehicle body component comprises a pivotably moveable flap.

17. A motor vehicle, comprising:
a vehicle body component;
an electric motor operable to move the vehicle body component, the electric motor having a rotor and a three-phase stator; and
a control device that is operable to perform operations that include:
loading two stator phases with a pulse-width-modulated voltage and maintaining a third stator phase at a free-floating state,
monitoring the third stator phase as a measuring point for an inductive voltage divider formed using the two stator phases, and
detecting movement of the vehicle body component when an electric signal at a measuring point or a variable derived from the electric signal exceeds a specified threshold value.

18. The motor vehicle of claim 17, wherein the control device is operable to perform operations that further include:
initiating, after the detection of the movement of the vehicle body component, an electrical movement of the vehicle body component to a closed position or an opened position depending on a direction of the detected movement.

19. The motor vehicle of claim 17, wherein the electric motor comprises a brushless DC (BLDC) motor.

20. The motor vehicle of claim 17, wherein the vehicle body component comprises a pivotably moveable flap.
